(19) United States
(12) Patent Application Publication
(10) Pub. No.: US 2013/0042312 A1
(43) Pub. Date: Feb. 14, 2013

(54) AUTHENTICATION IN A SMART THIN CLIENT SERVER

(71) Applicant: Glenn W. WICKMAN, San Jose, CA (US)

(72) Inventor: Glenn W. WICKMAN, San Jose, CA (US)

(73) Assignee: MOBILEFRAME LLC, Los Gatos, CA (US)

(21) Appl. No.: 13/470,152

(22) Filed: May 11, 2012

Related U.S. Application Data
(60) Provisional application No. 61/521,673, filed on Aug. 9, 2011.

(51) Int. Cl. H04L 9/32; G06F 15/16; G06F 21/00

(52) U.S. Cl. 726/7

(57) ABSTRACT

In a first embodiment of the present invention, a method for starting a session between a user and a smart thin client server is provided, wherein the smart thin client server permits users to create, manage, and deploy enterprise applications, the method comprising: receiving a request to initiate a session from a user, wherein the request does not include log-in credentials; selecting an anonymous account from a pool of anonymous accounts; obtaining credentials from the anonymous account; and establishing a session for the user using the credentials from the anonymous account.

### CROSS REFERENCE TO RELATED APPLICATIONS

This application claims the benefit of priority under 35 U.S.C. §119(e) to U.S. Provisional Patent Application No. 61/521,673, filed on Aug. 9, 2011, which is incorporated herein by reference in its entirety for all purposes.

### BACKGROUND OF THE INVENTION

1. Field of the Invention

The present invention relates generally to enterprise solutions. More specifically, the present invention relates to authenticating visitors to a thin client server website.

2. Description of the Related Art

Every business requires the completion and monitoring of various business processes. Commonly, many of these processes are performed using paper-based solutions, generally involving the completion and tracking of paper forms within an organization. The rise of mobile computing devices, however, has led to an increase in enterprise mobility solutions, where paper-based processes are replaced with wireless applications that are much more efficient. These enterprise mobility solutions, however, require custom programming.

One solution to this is to create a system where novice computer users are able to instantly create, manage, and deploy sophisticated mobile applications without the need for custom programming. All programming and synchronization complexities can be handled in the background, making them transparent to the business user.

One problem, however, with such a solution is that visitors to a website providing such functionalities need to be authenticated in some way.

### SUMMARY OF THE INVENTION

In a first embodiment of the present invention, a method for starting a session between a user and a smart thin client server is provided, wherein the smart thin client server permits users to create, manage, and deploy enterprise applications, the method comprising: receiving a request to initiate a session from a user, wherein the request does not include log-in credentials; selecting an anonymous account from a pool of anonymous accounts; obtaining credentials from the anonymous account; and establishing a session for the user using the credentials from the anonymous account.

In a second embodiment of the present invention, a method for maintaining a session between a smart thin client and a smart thin client server is provided, wherein the smart thin client server permits a user to create, manage, and deploy enterprise applications via the smart thin client, the method comprising: detecting a log-off event for the session between the smart thin client and the smart thin client server; and saving, by the smart thin client server, state information for the session, in a record containing a user identification corresponding to a user of the smart thin client.

In a third embodiment of the present invention, a smart thin client server for communication with one or more smart thin clients is provided, the smart thin client server comprising: a login/authentication handler configured to generate a login page; an anonymous account pool containing a plurality of anonymous accounts; and a session manager configured to, when a user does not enter log-in information in the login page but still requests a session, obtain credential information from an anonymous account in the anonymous account pool and create a session using the obtained credential information.

In a fourth embodiment of the present invention, a smart thin client server for communication with one or more smart thin clients is provided, the smart thin client server comprising: a login/authentication handler configured to generate a login page; a session manager configured to generate a session for a user; a memory storing a web session for the session; a session rendering engine; a value distribution handler; an image distribution handler; a dynamic value distribution handler; and a server management handler; wherein the session manager is further configured to: detect a log-off event for the session; and save state information for the session, in a record containing a user identification corresponding to the user.

In a fifth embodiment of the present invention, an apparatus for starting a session between a user and a smart thin client server is provided, wherein the smart thin client server permits users to create, manage, and deploy enterprise applications, the apparatus comprising: means for receiving a request to initiate a session from a user, wherein the request does not include log-in credentials; means for selecting an anonymous account from a pool of anonymous accounts; means for obtaining credentials from the anonymous account; and means for establishing a session for the user using the credentials from the anonymous account.

In a sixth embodiment of the present invention, an apparatus for maintaining a session between a smart thin client and a smart thin client server is provided, wherein the smart thin client server permits a user to create, manage, and deploy enterprise applications via the smart thin client, the apparatus comprising: means for detecting a log-off event for the session between the smart thin client and the smart thin client server; and means for saving, by the smart thin client server, state information for the session, in a record containing a user identification corresponding to a user of the smart thin client.

### BRIEF DESCRIPTION OF THE DRAWINGS

FIG. 1 is a block diagram illustrating a smart thin client server architecture in accordance with an embodiment of the present invention.

FIG. 2 is a diagram illustrating a web session in more detail in accordance with an embodiment of the present invention.

FIG. 3 is a block diagram illustrating a system with multiple smart thin client servers.

FIG. 4 is a flow diagram illustrating anonymous visitor authentication in accordance with an embodiment of the present invention.

FIG. 5 is a flow diagram illustrating named user authentication in accordance with an embodiment of the present invention.

FIG. 6 is a flow diagram illustrating a method for operating a session handler in accordance with an embodiment of the present invention.

FIG. 7 is a flow diagram illustrating a method for operating a session manager in accordance with an embodiment of the present invention.

FIG. 8 is a flow diagram illustrating a method for securely resuming a session in accordance with this embodiment of the present invention.

FIG. 9 is a flow diagram illustrating a method for handling the resuming of a session in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, a smart thin client server can be deployed to create, manage, and deploy enterprise applications that includes several different novel method of authentication to address these problems. In an embodiment of the present invention, an authentication system for a smart thin client server is provided. In this embodiment, users are provided with a smart thin client, requiring very few resources or alterations on the client side. The smart thin client allows users to access hosted applications via standard browsers. Furthermore, the smart thin client does not require the storage of data on the client side, making it easier to deploy in an enterprise, where some devices may not have available storage, and where security issues may prevent the storage of additional data on a client device.

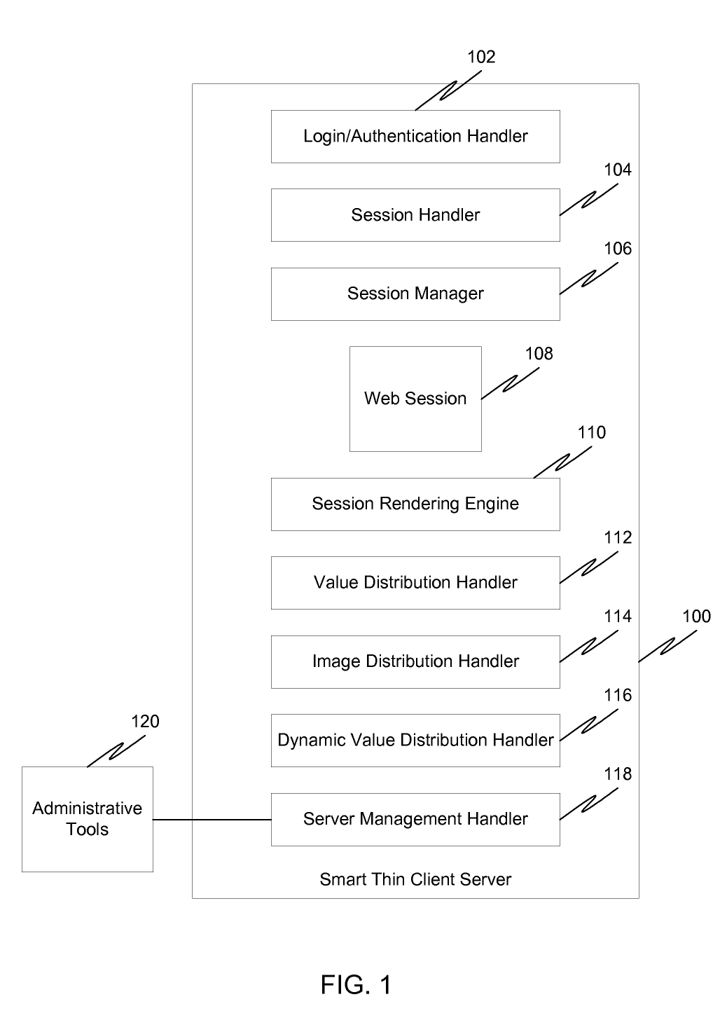

FIG. 1 is a block diagram illustrating a smart thin client server architecture in accordance with an embodiment of the present invention. As will be seen in this diagram, most of the processing elements are located on the smart thin client server, freeing up resources on the device containing a smart thin client. The smart thin client server 100 may contain a login/authentication handler 102. This component generates a login page and authenticates a user along with a session manager (described later) or forwards the user to an alternate server for servicing (also described later). The smart thin client server 100 may also contain a session handler 104. This component responds to browser requests for or post backs from a rendered session. This component also confirms session validity, processes input, and returns a current session state as HTML.

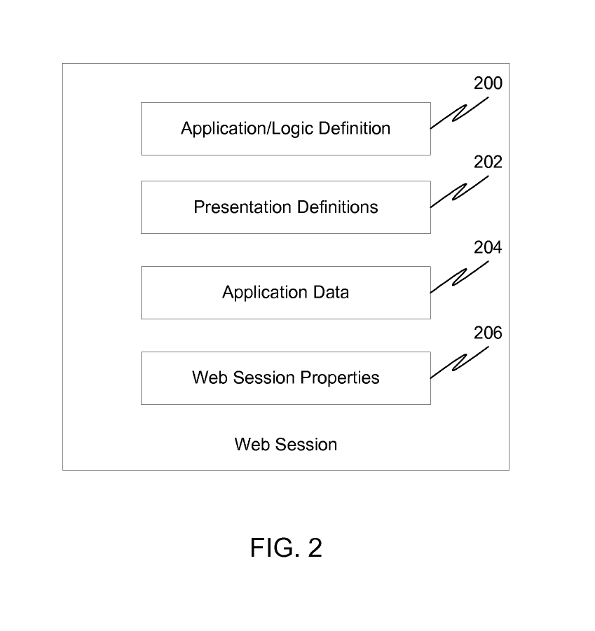

The smart thin client server 100 may also contain a session manager 106. This component creates new sessions or restores existing sessions. Generally it is responsible for cleanup and management of idle sessions. The smart thin client server 100 may also contain a web session 108. The web session 108 is a data structure that retains all application data, user interface designs, and session-specific data. FIG. 2 is a diagram illustrating a web session 108 in more detail in accordance with an embodiment of the present invention. An application/logic definition 200 contains all fields of data, data types, and options of the values allowed. It contains all workflow (logic) flow on any events within those fields of data (changing a value for example). It also contains any global application properties as well as properties specific to individual fields.

Presentation definitions 202 contain all visual elements associated with the application presentation (user interface) for a particular device and language. Elements may or may not correspond to a field of data in the application.

Application data 204 contains all values and dynamically adjustable properties for every field of data for every instance of any application running within the user's session.

Web session properties 206 contain properties specific to a particular active web session. Examples include session/transaction tokens, database connections, browser information, last access time, etc.

Referring back to FIG. 1, the smart thin client server 100 also may contain a session rendering engine 110. This component generates and optionally optimizes the HTML that corresponds to the current page in a web session.

The smart thin client server 100 may also contain a value distribution handler 112. This component returns values from browser requests, including but not limited to rich data type values like files.

The smart thin client server 100 may also contain an image distribution handler 114. This component returns optimized images from browser requests. Images may be data in the user's session or part of the defined user interface.

The smart thin client server 100 may also contain a dynamic value distribution handler 116. This component returns partial HTML from browser requests supporting dynamic or on-demand pulling of data values.

The smart thin client server 100 may also contain a server management handler 118. This component provides a request point for managing a server via administrative tools 120. Examples include the ability to query/manage the server (i.e., start, stop, restart) and query/manage web sessions.

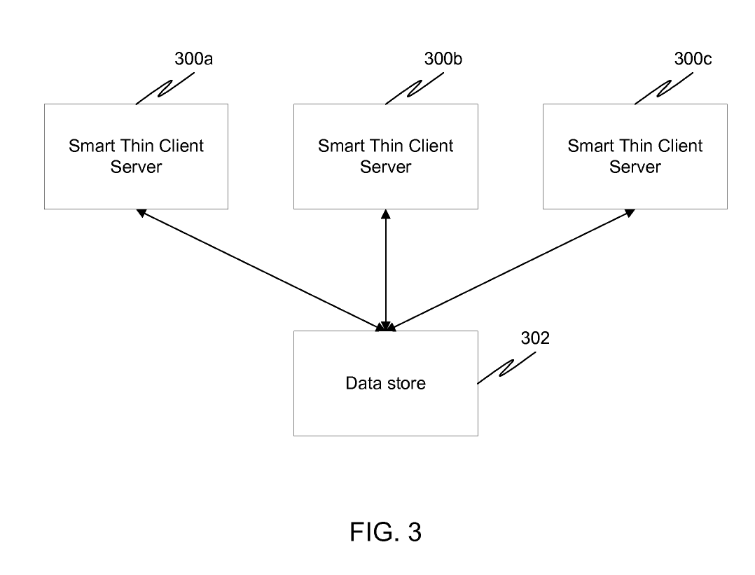

A single system may have multiple smart thin client servers, in order to better balance the computing load in the system. FIG. 3 is a block diagram illustrating a system with multiple smart thin client servers. Smart thin client servers 300a, 300b, 300c all may connect to a single data store 302, such as a database. This system allows for separate web-sites for each smart thin client server, scalability/web farming, or other segregation of users and/or functionality.

The most commonly used type of authentication is named user authentication. In named user authentication, a user registers for an account with the system and is assigned a user name and password. Upon visiting the website, the user provides the user name and password, and the system authenticates the user name and password prior to granting access to the website. This solution, however, requires that users actively register for accounts. Some users may not wish to actively register, or may be unable to for some reason. Thus, one goal of the present invention is to provide a system where users can access the website without actively registering for an account.

One way such non-registered users have accessed websites in the past is through the use of cookies. A cookie is a small file stored on the client computer during a web session. The cookie may store some sort of identification for the user, and thus when a user logs in again later, this cookie may be used to recognize the user from the previous session. The cookie may also be used to store various types of information that the systems wants to persist between sessions. For example, a web browser may store a cookie on the user's computer containing past search queries. The problem is that such a cookie-based solution would not work with a thin-client, because a thin client does not want to utilize space on the client computer.

Furthermore, the ability to have state persistence is limited in prior art systems. While some state information can be saved in a cookie, this information is lost if the cookie is lost or unavailable. So a user whose computer is lost, erased, or who is simply using a different computer will not be able to access the previous state information. While this may be fine for the relatively unimportant data typically stored in cookies, such as search queries, products browsed, and other session information, in the enterprise software deployment world, the loss or inaccessibility of state information related to the creation or management of enterprise software can be devastating. What is needed is a solution that permits true state persistence without requiring resources on the client computer.

In one embodiment of the present invention, automatic anonymous authentication is provided for those users who do not wish or are unable to register for a user name and password. In such an embodiment, any visitor to the website is automatically logged in as a user from a pool of anonymous user accounts configured by an administrator. This pool can be limited in order to aid in limiting the number of simultaneous anonymous connections to the server. Thus, the user is still getting a user account, even though no registration has been made and no data is stored on the client device.

In an embodiment of the present invention, through the user of an anonymous user account, a user who cannot or doesn't wish to register for a user name or password can still obtain a database connection and utilize the application logic on a smart thin client server. This allows the user to continue to utilize only a smart thin client on the user device.

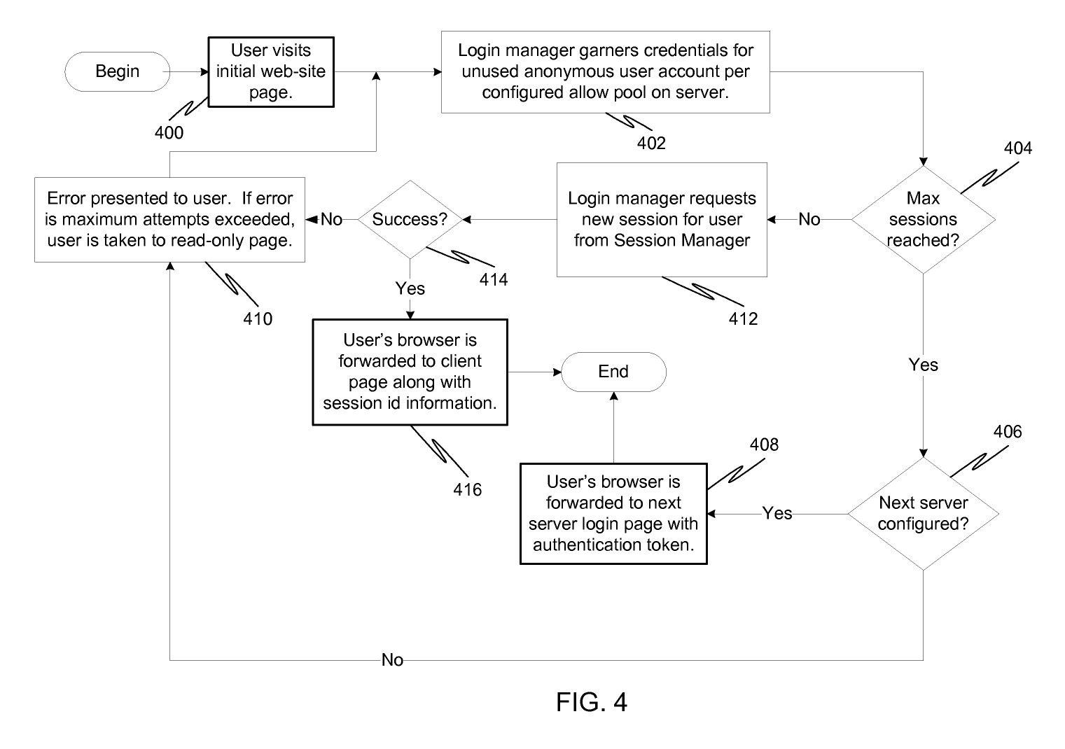

FIG. 4 is a flow diagram illustrating anonymous visitor authentication in accordance with an embodiment of the present invention. At 400, a user visits the initial website page. At 402, the login manager garners credentials for unused anonymous user accounts from a pool on the server. At 404, it is determined if a maximum number of sessions has been reached. Limiting the maximum number of sessions allows for better load balancing. Multiple smart thin client servers can be deployed additional simultaneous sessions are required. Thus, if the maximum number of sessions has been reached, at 406 it is determined if the next smart thin client server has been configured. If so, then at 408 the user's browser is forwarded to the next server login page with an authentication token from the pool. If not, then at 410 an error is presented to the user. If the maximum number of sessions was not reached at 404, then at 412, a login manager requests a new session for the user from a session manager. At 414, it is determined if this is successful (i.e., if the virtual device has been successfully assigned to the user). If so, then at 416, the user's browser is forwarded to a client page, along with session identification information. At this point, the process can be handed to a session handler sequence, which will be described in more detail below.

In another embodiment of the present invention, persistent state storage is provided on the server side without saving any data on the client machine. This includes cookies. When a user utilizes a named user authentication method, a virtual device is assigned to the user once the user's user name and password are authenticated. All state information is then saved on the server side as the creation, management, and deployment of apps is performed on the website.

In another embodiment of the present invention, the user is able to configure what state information is stored on the server. This user-configurable state storage allows the user to define which states are most important to save in a custom manner. For example, the user could specify that the state information about app authoring as well as the data the apps collect is saved. This would be different than a traditional auto-save environment, where the states saved are fixed by the developer of the website.

Another difference from the prior art is that the state information that is saved is state information about authoring the user's own applications, as well as the data that they have been collecting using those applications. As such, the result is an enterprise controlled centrally managed server maintaining state information about authoring applications.

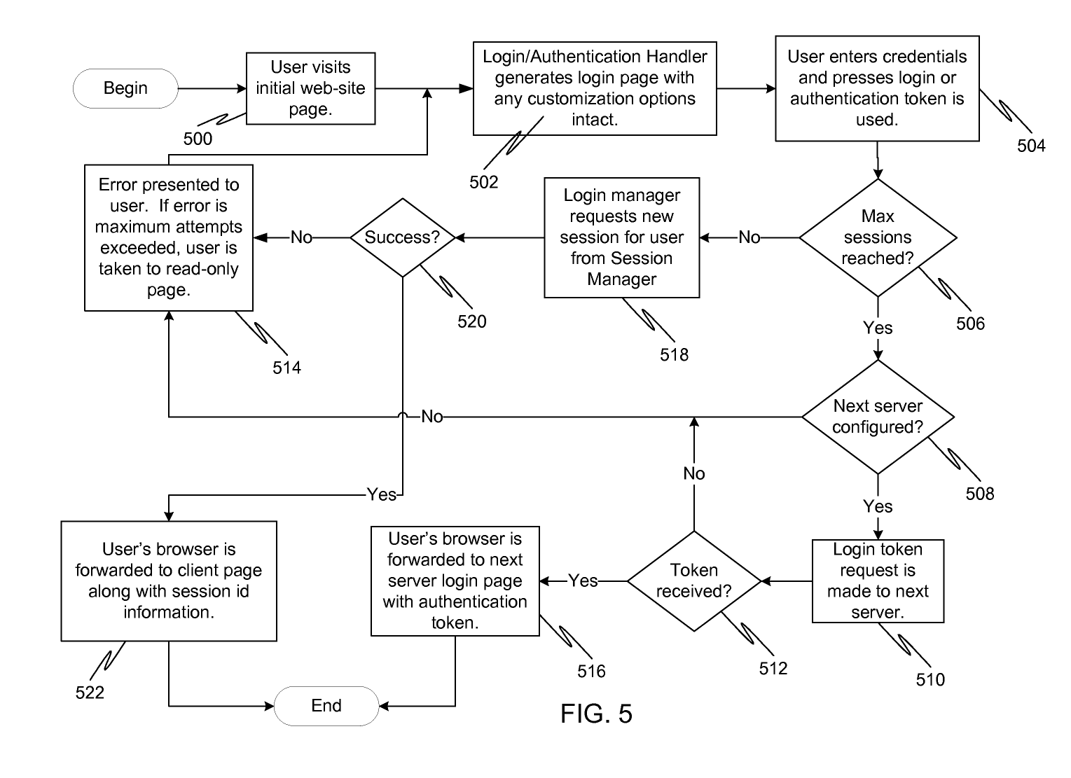

FIG. 5 is a flow diagram illustrating named user authentication in accordance with an embodiment of the present invention. At 500, a user visits the initial website page. At 502, a login/authentication handler generates a login page with any customization options intact. At 504, the user enters credentials and presses login (or an authentication token is used). At 506, it is determined if a maximum number of sessions has been reached. If the maximum number of sessions has been reached, at 508 it is determined if the next smart thin client server has been configured. If so, then at 510 a login token request is made to the next server. Then at 512 it is determined if the next token has been received. If not, then at 514 an error is presented to the user. This error may also be presented if the next server was determined not to be configured at 508. If at 512 it is determined that the token was received, then at 516 the user's browser is forwarded to the next server login page with an authentication token from the pool. If the maximum number of sessions was not reached at 506, then at 518, a login manager requests a new session for the user from the session manager. At 520, it is determined if this is successful (i.e., if the virtual device has been successfully assigned to the user). If so, then at 522, the user's browser is forwarded to a client page, along with session identification information. At this point, the process can be handed to a session handler sequence, which will be described in more detail below.

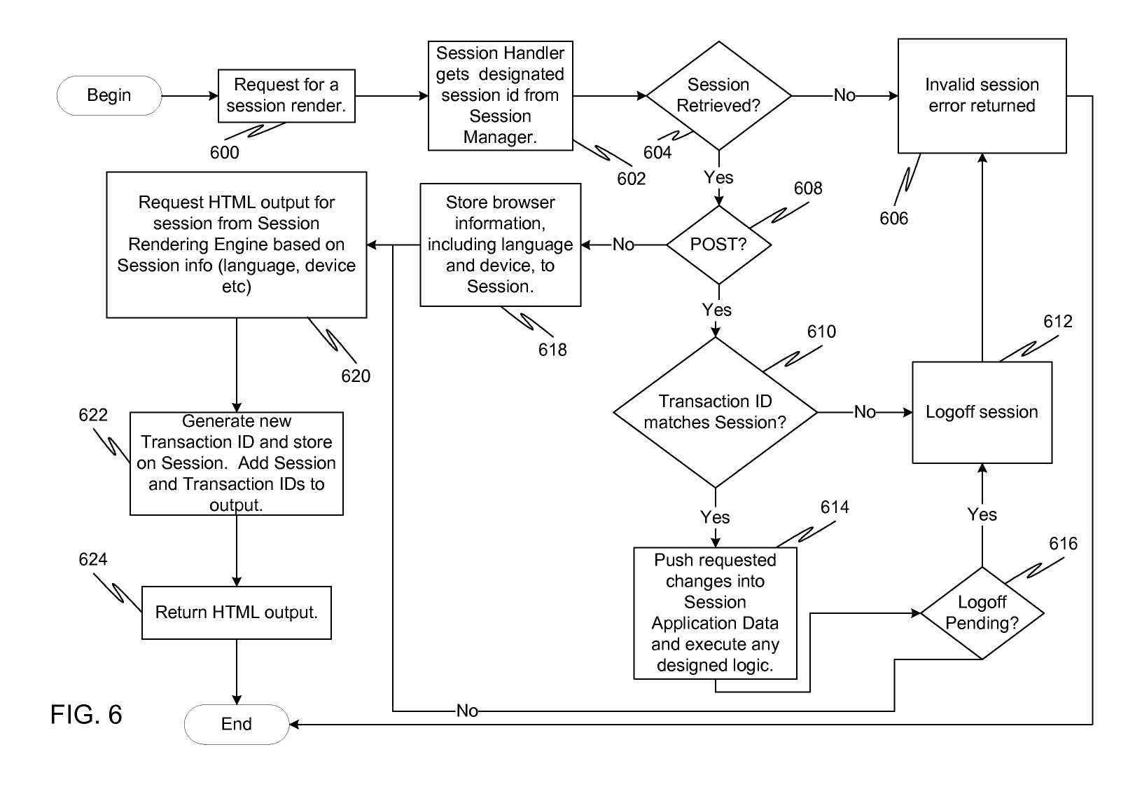

FIG. 6 is a flow diagram illustrating a method for operating a session handler in accordance with an embodiment of the present invention. At 600, a request for a session render is received. At 602, the session handler gets the designated session identification from the session manager. At 604, it is determined if a session was received. If not, then at 606 an error is returned. If so, then at 608 it is determined if the request is a POST request. If so, then at 610 it is determined if the transaction identification of the request matches the session. If not, then at 612 the session is logged off. This is described in more detail below. If the transaction identification matches the session, then at 614 the requested changes are pushed into session application data and any designed logic is executed. Then at 616, it is determined if there is a logoff pending. If so, then the system moves to 612 where the session is logged off. If not, the process will proceed to 620, which will be discussed in more detail below.

If at 608 it was determined that the request was not a POST request (i.e., it was a GET request), then at 618 the browser information, including language and device, may be stored in the session. At 620, HTML output for the session is requested from a session rendering engine based on session information. At 622, a new transaction identification is generated and stored on the session. The session and transaction identifications may be added to output. At 624, the HTML output is returned.

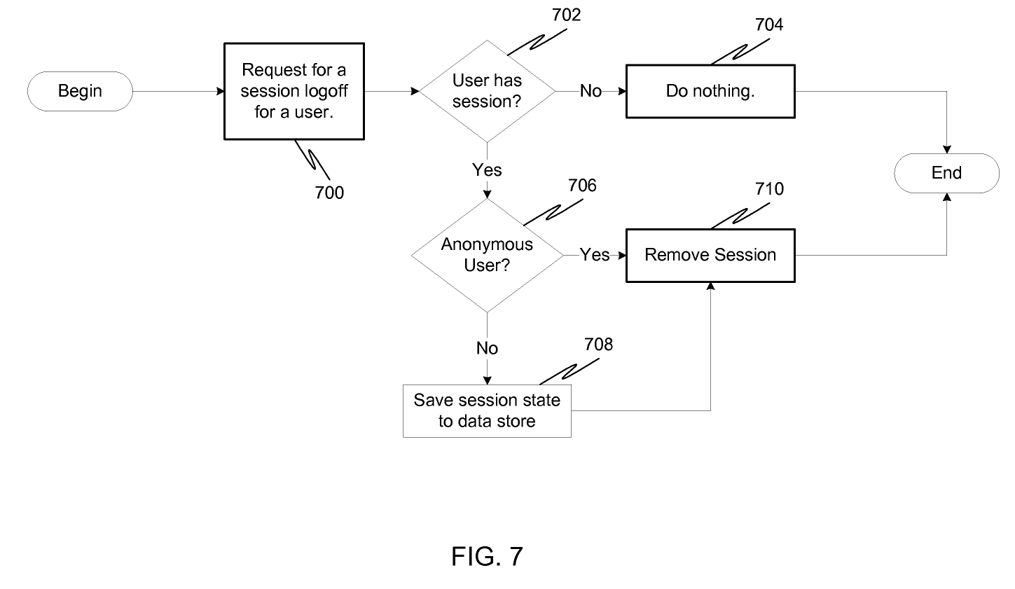

FIG. 7 is a flow diagram illustrating a method for operating a session manager in accordance with an embodiment of the present invention. At 700, a request for a session logoff for a user is received. At 702, it is determined if the user has a current session. If not, then at 704 the process ends. This might occur, for example, if the session logoff request was issued in error. If the user has a session, then at 706 it is determined if the user is an anonymous user. If not, then the session state can be saved to a data store at 708. Following that, or if the user was an anonymous user, then at 710 the session can be removed.

Of course, the user explicitly logging off may be just one of the possible catalysts for the saving of the session state information. In another embodiment of the present invention, a user “time out” is detected, where there have been no session activity for a predefined amount of time (as defined by an administrator). In essence, this is an implicit log off. In another embodiment of the present invention, an administrator can forcibly log off a user via a remote console. In another embodiment of the present invention, the thin client server may receive a shut down: notice from an operating system where all users must be logged off and session state information stored. Lastly, in an embodiment of the present invention, as part of an application workflow logic, the application itself can issue an explicit request to save the state information.

A user ID can be used to save a record for the session that includes the state information. The actual storage of the web session state information can be performed using a variety of different mechanisms. In one embodiment of the present invention, a web session table is utilized. The web session table as a column for the user ID as well as session bytes (a binary large object bytes (BLOB) column). Each record in this table represents a user's web session state. The user column may be the primary key, because there is only one state per user. Records can then be read from or written to this table. In that manner, all sessions are centrally stored and secured, regardless of how many actual thin client servers are actually operating.

In another embodiment of the present invention, the state information can be stored in simple files, using the user ID as the name of each file. Alternatively, a dedicated session server may be utilized, eliminating the need for a database.

The state information stored may be reflective of the fact that the web session itself is essentially a mini-virtual machine that includes apps (current or on hold), pending data, and user preferences. The web session is an object that contains everything a user is working on. The web sessions can then be serialized into byte form.

Thus, in one embodiment of the present invention, a user's web session is stored by first serializing the user's session to bytes, and then inserting or updated the web sessions table with the bytes corresponding to the user ID.

Restoring the session then involves finding the user ID in the web sessions table, obtaining the bytes for the user id, and deserialize them back into an instantiated web session. If there were no bytes found, then the session is a new session and a new object instances is created for the user.

In an embodiment of the present invention, every thin client server web session has an associated client ID. The client session ID identifies the web session. This client session ID an then be used to pass as a parameter for certain function calls. For example, a user can use a URL operation on the platform to redirect the user to a different web server, and the client session ID can be passed as a parameter to this operation in order to identify the session to redirect. To return back. The client session ID can be passed between any applications on the platform, even user defined applications, allowing a degree of flexibility not found in prior art solutions.

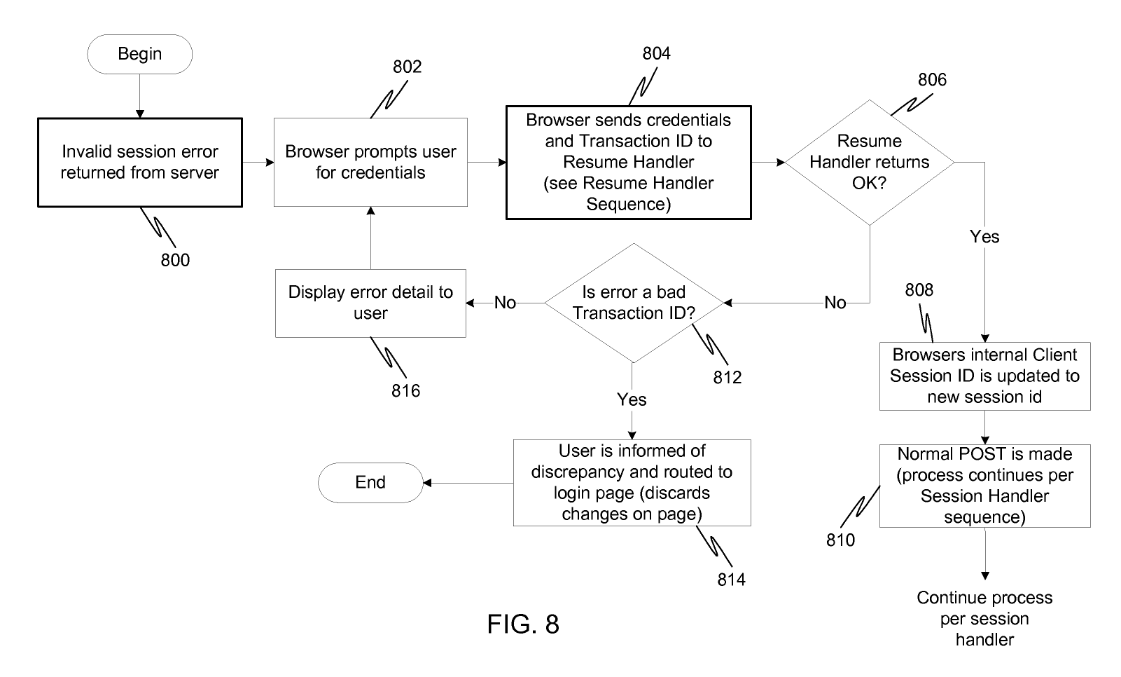

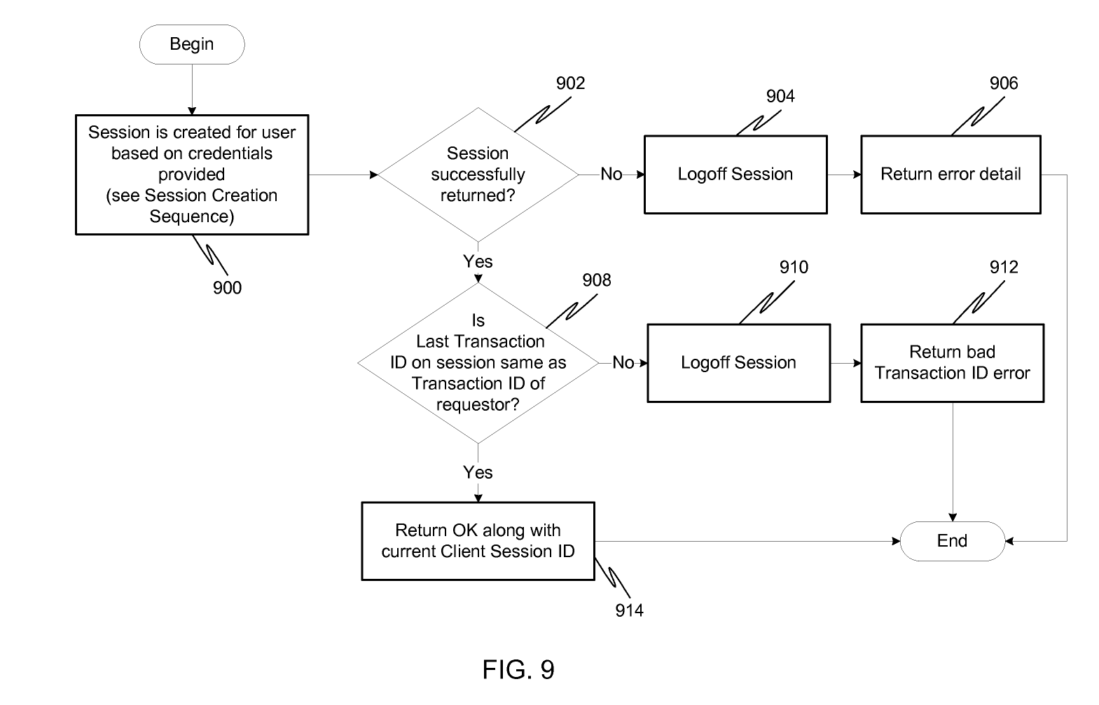

In another embodiment of the present invention, a sequence is provided that allows the system to securely resume a session that was logged off due to idle time or disconnected from the server. FIG. 8 is a flow diagram illustrating a method for securely resuming a session in accordance with this embodiment of the present invention. In such a case, an invalid session error is returned from the server at 800. At 802, the browser then prompts the user for credentials. At 804, the browser sends the credentials and the transaction ID to the resume handler sequence. The resume handler sequence will be described later with respect to FIG. 9. At 806, it is determined if the resume handler returns an “OK”. If so, then at 808 the browser's internal client session ID is updated to a new session ID. Then at 810, a normal POST operation is made (and the process continues per the session hander sequence).

If at 806, it is determined that the resume handler did not return an “OK”, then at 812 it is determined if the error is a bad transaction ID. If so, then the user is informed of the discrepancy and routed to the login page (at which point the changes on the page are discarded) at 814. If not, then at 816 the error detail is displayed to the user.

FIG. 9 is a flow diagram illustrating a method for handling the resuming of a session in accordance with an embodiment of the present invention. Here, at 900, a session is created for the user based on credentials provided. Then, at 902, it is determined if a session is successfully returned. If not, then at 904 the session is logged off and at 906 error details are returned. If so, then at 908 it is determined if the last transaction ID on the session the same as the transaction ID of the requester. If not, then at 910 the session is logged off and at 912 a bad transaction ID error is returned. If so, then at 914, an “OK” is returned along with the current client session ID.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method for starting a session between a user and a smart thin client server, wherein the smart thin client server permits users to create, manage, and deploy enterprise applications, the method comprising:
receiving a request to initiate a session from a user, wherein the request does not include log-in credentials;
selecting an anonymous account from a pool of anonymous accounts;
obtaining credentials from the anonymous account; and
establishing a session for the user using the credentials from the anonymous account.

2. The method of claim 1, wherein the pool of anonymous accounts is limited in number in order to aid in limiting the number of simultaneous anonymous connections to the smart thin client server.

3. The method of claim 1, wherein the request does not include log-in credentials because the user is unwilling to provide log-in credentials.

4. The method of claim 1, wherein the request does not include log-in credentials because the user is unable to provide log-in credentials.

5. A method for maintaining a session between a smart thin client and a smart thin client server, wherein the smart thin client server permits a user to create, manage, and deploy enterprise applications via the smart thin client, the method comprising:
detecting a log-off event for the session between the smart thin client and the smart thin client server; and
saving, by the smart thin client server, state information for the session, in a record containing a user identification corresponding to a user of the smart thin client.

6. The method of claim 5, wherein the log-off event is a user explicitly logging off of the session.

7. The method of claim 5, wherein the log-of event is inferred from a lack of activity of a user of the smart thin client.

8. The method of claim 5, wherein the log-off event is inferred from detection of a shut-down notice from an operating system of the client.

9. The method of claim 5, wherein the log-off event includes an explicit request to log-off from an enterprise application managed by the smart thin client server.

10. The method of claim 5, wherein the state information saved by the smart thin client server is configurable by a user of the smart thin client.

11. The method of claim 5, wherein the state information includes application authoring state and state of variable for data collected by applications managed by the smart thin client server on behalf of the smart thin client.

12. The method of claim 5, wherein the smart thin client is unable to store state information for the session.

13. The method of claim 12, wherein the smart thin client is unable to store cookies.

14. The method of claim 5, further comprising:
receiving a command to resume the session;
prompting the user for credentials;
sending the credentials and a transaction identification to a resume handler;
receiving an affirmative response from the resume handler; and
updating an internal client session identification with a new session identification.

15. The method of claim 14, resume handler performs the following:
creating as session for the user based on credentials provided;
determining if the last transaction identification on the session is the same as a transaction identification of a requester; and
returning an affirmative if the last transaction identification on the session is the same as a transaction identification of the requester.

16. A smart thin client server for communication with one or more smart thin clients, the smart thin client server comprising:
a login/authentication handler configured to generate a login page;
an anonymous account pool containing a plurality of anonymous accounts; and
a session manager configured to, when a user does not enter log-in information in the login page but still requests a session, obtain credential information from an anonymous account in the anonymous account pool and create a session using the obtained credential information.

17. A smart thin client server for communication with one or more smart thin clients, the smart thin client server comprising:
a login/authentication handler configured to generate a login page;
a session manager configured to generate a session for a user;
a memory storing a web session for the session;
a session rendering engine;
a value distribution handler;
an image distribution handler;
a dynamic value distribution handler; and
a server management handler;
wherein the session manager is further configured to:
detect a log-off event for the session; and
save state information for the session, in a record containing a user identification corresponding to the user.

18. The smart thin client server of claim 17, wherein the web session includes:
an application/logic definition;
one or more presentation definitions;
application data; and
web session properties.

19. An apparatus for starting a session between a user and a smart thin client server, wherein the smart thin client server permits users to create, manage, and deploy enterprise applications, the apparatus comprising:
means for receiving a request to initiate a session from a user, wherein the request does not include log-in credentials;
means for selecting an anonymous account from a pool of anonymous accounts;
means for obtaining credentials from the anonymous account; and
means for establishing a session for the user using the credentials from the anonymous account.

20. An apparatus for maintaining a session between a smart thin client and a smart thin client server, wherein the smart thin client server permits a user to create, manage, and deploy enterprise applications via the smart thin client, the apparatus comprising:
means for detecting a log-off event for the session between the smart thin client and the smart thin client server; and
means for saving, by the smart thin client server, state information for the session, in a record containing a user identification corresponding to a user of the smart thin client.
